(19) United States
(12) Patent Application Publication
(10) Pub. No.: US 2008/0272996 A1
(43) Pub. Date: Nov. 6, 2008

(54) DISPLAY SYSTEM AND COMPENSATION CIRCUIT THEREOF

(75) Inventor: Yu-Hsiao Wu, Nantou County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/945,997

(22) Filed: Nov. 27, 2007

(30) Foreign Application Priority Data
May 4, 2007 (TW) TW96115866

(51) Int. Cl. G09G 3/36

(52) U.S. Cl. 345/87

(57) ABSTRACT

A display system comprises an adjustment unit, a pulse generating unit and a light tube. The adjustment unit comprises a thermal resistor and generates an adjustment signal according to the temperature. The pulse generating unit generates a pulse driving signal according to the adjusting signal. When the temperature falls, the duty cycle of the pulse driving signal is increased. When the temperature rises, the duty cycle of the pulse driving signal is decreased. The light tube emits light according to the duty cycle of the pulse driving signal.

### BACKGROUND OF THE INVENTION

1. Field of the Invention

The invention relates to a display system, and in particular relates to a compensation circuit of a liquid crystal display system.

2. Description of the Related Art

The convention liquid crystal display system comprises a plurality of light tubes to provide light and controls the liquid crystal by using electrodes to let light go through the liquid crystal or not, to display an image. However, due to electrical characteristics of light tubes, the equivalent resistance of light tubes will gradually decrease and the current going through the light tubes will gradually increase to cause unstable operation of the light tubes and failure to meet the specification. The unstable operation will cause the light tubes to illuminate more than necessary and decrease life time thereof, or to illuminate less than required. In brief, the unstable electrical characteristics of the light tubes will cause the liquid crystal display to emit light unstably.

With regard to manufacturing, due to the unstable electrical characteristics of the light tubes, production yield rate decreases. Alternatively, additional calibration has to be implemented during the manufacturing process to have the current go through the light tubes to meet the desired specification. However, the additional process would also increase manufacturing costs. Thus, solving the problem of the conventional liquid crystal display system which unstably emits light is discussed in this invention.

### BRIEF SUMMARY OF THE INVENTION

A detailed description is given in the following embodiments with reference to the accompanying drawings.

An embodiment of a display system is provided. The display system comprises an adjusting unit, a pulse generating unit and a light tube. The adjusting unit comprises a thermal resistor and generates an adjusting signal according to environment temperature and a DC voltage. The pulse generating unit generates a pulse driving signal with a first duty cycle according to the adjusting signal. The light tube emits light according to the first duty cycle of the pulse driving signal.

Another embodiment of a display system is provided. The display system comprises an adjusting unit, a pulse width modulation controller, a first driving circuit, a second driving circuit, a first transformer and a light tube. The adjusting unit comprises a thermal resistor and generates an adjusting signal according to environment temperature and a DC voltage. The pulse width modulation controller generates a first pulse signal with a first duty cycle and a second pulse signal with a second duty cycle according to a voltage level of the adjusting signal. The first driving circuit generates a first driving signal according to the first pulse signal. The second driving circuit generates a second driving signal according to the second pulse signal. The first transformer receives the first driving signal and the second driving signal to generate a pulse driving signal with a third duty cycle. The light tube emits light according to the third duty cycle of the pulse driving signal.

### BRIEF DESCRIPTION OF THE DRAWINGS

The invention can be more fully understood by reading the subsequent detailed description and examples with references made to the accompanying drawings, wherein:

FIG. 1 is a light tube thermal drift compensation circuit according to an embodiment of the invention;

FIG. 2 is a light tube thermal drift compensation circuit according to another embodiment of the invention;

FIG. 3 is a light tube thermal drift compensation circuit according to another embodiment of the invention; and

FIG. 4 is a light tube thermal drift compensation circuit according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

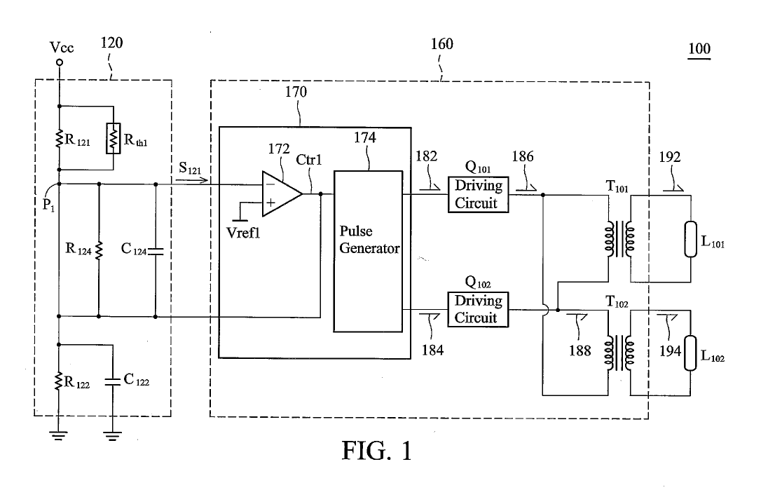

FIG. 1 is a light tube thermal drift compensation circuit 100 according to an embodiment of the invention. Compensation circuit 100 can be used in a display system, especially in a liquid crystal display system. Compensation circuit 100 comprises adjusting unit 120, pulse generating unit 160 and light tubes L₁₀₁ and L₁₀₂. Adjusting unit 120 comprises resistors R₁₂₁, R₁₂₂ and R₁₂₄, negative temperature coefficient thermal resistor Rₜₕ₁ (i.e. NTC thermistor), and capacitors C₁₂₄ and C₁₂₂, as shown in FIG. 1. Negative temperature coefficient thermal resistor Rₜₕ₁ and resistor R₁₂, are coupled in parallel and between DC voltage Vcc and node p1. Resistor R₁₂₂ and capacitor C₁₂₂ are individually coupled between node P1 and ground. Adjusting unit 120 generates adjusting signal S₁₂₁ at node P1 according to resistors R₁₂, and R₁₂₂ and thermal resistor Rₜₕ₁. Resistor R₁₂₄ and capacitor C₁₂₄ are coupled between node P1 and pulse generating unit 160 for compensation circuit 100 stability. Pulse generating unit 160 comprises pulse width modulation (PWM) controller 170, driving circuits Q₁₀₁ and Q₁₀₂ and transformers T₁₀₁ and T₁₀₂. Pulse width modulation controller 170 comprises comparator 172 and pulse generator 174. Comparator 172 compares adjusting signal S₁₂₁ to reference voltage V_{ref1} to generate control signal Ctr1. Pulse generator 174 generates pulse signals 182 and 184 according to control signal Ctr1. Driving circuits Q₁₀₁ and Q₁₀₂, respectively receive pulse signals 182 and 184 to generate driving signals 186 and 188. It is noted that the first phase difference is between pulse signal signals 182 and 184 and the second phase difference is between driving signals 186 and 188. Normally, the first and second phase differences are the same. Transformers T₁₀₁ and T₁₀₂, respectively transform driving signals 186 and 188 into pulse driving signals 192 and 194 to drive light tubes L₁₀₁ and L₁₀₂.

According to an embodiment of the invention, thermal resistor Rₜₕ₁ can be disposed near pulse generator 160. For example, thermal resistor Rₜₕ₁ can be disposed near pulse width modulation controller 170 or light tube L₁₀₁ or L₁₀₂ to detect environment temperature so as to adjust resistance value to change the voltage level of adjusting signal S₁₂₁. Following an operating period of compensation circuit 100, environment temperature or internal temperature of compensation circuit 100 rises. Since thermal resistor Rₜₕ₁ is a negative temperature coefficient thermal resistor in this embodiment, the resistance value of thermal resistor Rₜₕ₁ decreases when environment temperature or internal temperature of compensation circuit 100 rises. The voltage level of adjusting signal S₁₂₁ increases and the voltage level of control signal Ctr1 decreases. Pulse generator 174 generates pulse signals 182 and 184 according to the voltage level of control signal Ctr1. When the voltage level of control signal Ctr1 decreases because of temperature rise, the duty cycles of pulse signals 182 and 184 decrease. Driving circuits Q₁₀₁ and Q₁₀₂ generate driving signals 186 and 188 without changing the duty cycles according to pulse signals 182 and 184. Thus, the duty cycles of driving signals 186 and 188 are the same as those of pulse signals 182 and 184. Transformers T₁₀₁ and T₁₀₂ only change the voltage levels but do not change the duty cycles when transformers T₁₀₁ and T₁₀₂ transform driving signals 186 and 188 into pulse signals 192 and 194, respectively. When environment temperature rises, the duty cycles of driving signals 186 and 188 decrease and the duty of cycles of pulse signals 192 and 194 also decrease. Thus, the emitting light time of light tubes L₁₀₁ and L₁₀₂ decreases accordingly to reduce heat generation and to decrease the environment temperature. According to another embodiment of the invention, when the currents going through light tubes L₁₀₁ and L₁₀₂ decrease, the illumination and heat of light tubes L₁₀₁ and L₁₀₂ decreases and the environment temperature falls, Thus, the voltage level of adjusting signal S₁₂₁ decreases, the voltage level of control signal Ctr1 increases, the duty cycles of pulse signals 182 and 184 increase, the duty cycles of driving signals 186 and 188 increase and the duty cycles of pulse signals 192 and 194 also increase. Consequently, the emitting light time of light tubes L₁₀₁ and L₁₀₂ increases to improve the problem that light tubes L₁₀₁ and L₁₀₂ may not be illuminated enough. Meanwhile, light tubes L₁₀₁ and L₁₀₂ can be Cold Cathode Fluorescent Lamps (CCFL).

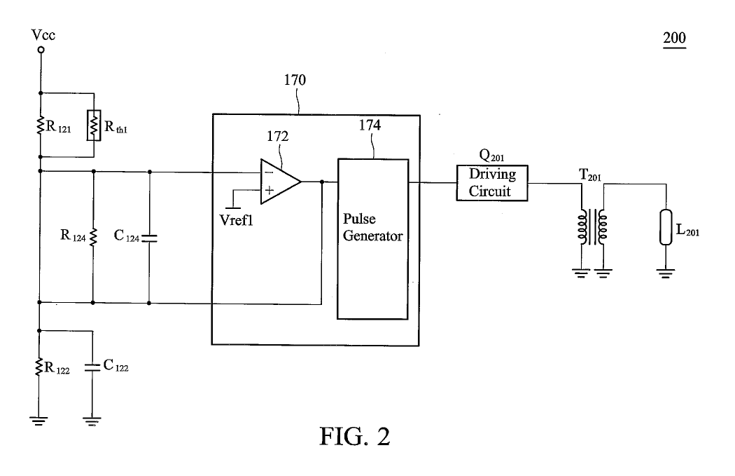

FIG. 2 is a light tube thermal drift compensation circuit 200 according to another embodiment of the invention. The difference between compensation circuit 200 and compensation circuit 100 is that compensation circuit 200 only comprises single driving circuit Q₂₀₁, single transformer T₂₀₁ and single light tube L₂₀₁. Other components of compensation circuit 200 are the same as those of compensation circuit 100. The operations of compensation circuits 200 and 100 are substantially the same other than aforementioned difference. Compensation circuit 200 also uses thermal resistor Rₜₕ₁ to detect environment temperature or internal temperature of compensation circuit 200 to control the current going through light tube L₂₀₁ to control emitting light time thereof.

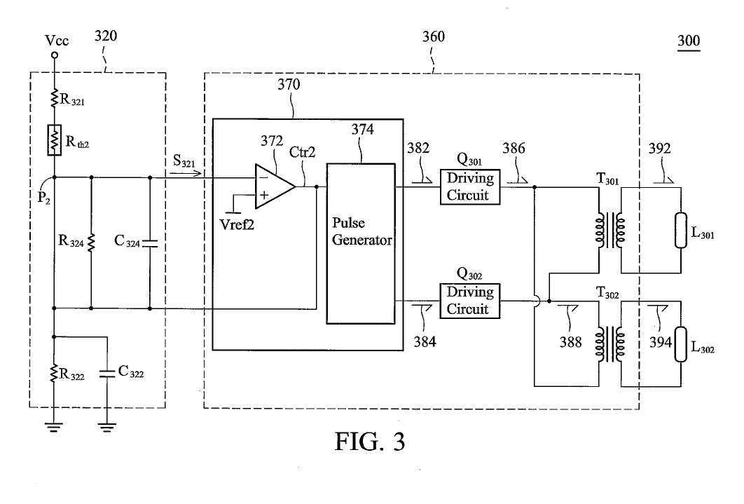

FIG. 3 is a light tube thermal drift compensation circuit 300 according to another embodiment of the invention. Compensation circuit 300 can be used in a display system, especially in a liquid crystal display system. Compensation circuit 300 comprises adjusting unit 320, pulse generating unit 360 and light tubes L₃₀₁ and L₃₀₂. Adjusting unit 320 comprises resistors R₃₂₁, R₃₂₂ and R₃₂₄, negative temperature coefficient thermal resistor Rₜₕ₂, and capacitors C₃₂₄ and C₃₂₂, as shown in FIG. 3. Negative temperature coefficient thermal resistor Rₜₕ₂ and resistor R₃₂₁ are coupled in series and between DC voltage Vcc and node p2. Resistor R₃₂₂ and capacitor C₃₂₂ are coupled between node P2 and ground. Adjusting unit 320 generates adjusting signal S₃₂₁ at node P2 according to resistors R₃₂₁ and R₃₂₂ and thermal resistor Rₜₕ₂. Resistor R₃₂₄ and capacitor C₃₂₄ are individually coupled between node P2 and pulse generating unit 360 for compensation circuit 300 stability. Pulse generating unit 360 comprises pulse width modulation (PWM) controller 370, driving circuits Q₃₀₁ and Q₃₀₂ and transformers T₃₀₁ and T₃₀₂. Pulse width modulation controller 370 comprises comparator 372 and pulse generator 374. Comparator 372 compares adjusting signal S₃₂₁ to reference voltage V_{ref2} to generate control signal Ctr2. Pulse generator 374 generates pulse signals 382 and 384 according to control signal Ctr2. Driving circuits Q₃₀₁ and Q₃₀₂ respectively receive pulse signals 382 and 384, to generate driving signals 386 and 388. The third phase difference is between pulse signal signals 382 and 384. The fourth phase difference is between driving signals 386 and 388. Normally, the third and fourth phase differences are the same. Transformers T₃₀₁ and T₃₀₂, respectively transform driving signals 386 and 388 into pulse driving signals 392 and 394 to drive light tubes L₃₀₁ and L₃₀₂.

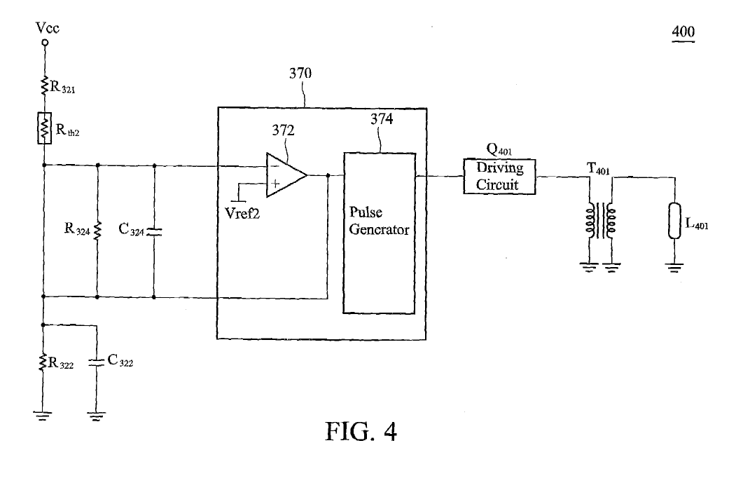

FIG. 4 is a light tube thermal drift compensation circuit 400 according to another embodiment of the invention. The difference between compensation circuit 400 and compensation circuit 300 is that compensation circuit 400 only comprises single driving circuit Q₄₀₁, single transformer T401 and single light tube L₄₀₁. Other components of compensation circuit 400 are the same as those of compensation circuit 300. The operations of compensation circuits 400 and 300 are substantially the same other than aforementioned difference. Compensation circuit 400 also uses thermal resistor Rₜₕ₂ to detect environment temperature and/or internal temperature of compensation circuit 400 to control the current going through light tube L₄₀, so as to control emitting light time thereof.

It is not limited to use a negative temperature coefficient thermal resistor to detect environment temperature so as to control the current going through the light tube to control emitting light time. A positive temperature coefficient thermal resistor can also work in this invention.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display system, comprising
an adjusting unit, comprising a thermal resistor with a resistance value and generating an adjusting signal with a first voltage level according to a temperature;
a pulse generating unit, generating a pulse driving signal with a first duty cycle according to the adjusting signal; and
a light tube, emitting light according to the first duty cycle of the pulse driving signal.

2. The display system as claimed in claim 1, wherein when the first duty cycle of the pulse driving signal increases, a emitting light time of the light tube increases and when the first duty cycle of the pulse driving signal decreases, the emitting light time of the light tube decreases.

3. The display system as claimed in claim 1, wherein the light tube is used in a liquid crystal display system.

4. The display system as claimed in claim 1, wherein the adjusting unit comprises:
a first resistor, coupled to the thermal resistor in parallel; and
a second resistor, coupled between the ground and the thermal resistor.

5. The display system as claimed in claim 1, wherein the adjusting unit comprises:
a first resistor, coupled to the thermal resistor in series; and
a second resistor, coupled between the ground and the thermal resistor.

6. The display system as claimed in claim 1, wherein the thermal resistor adjusts the resistance value according to the temperature to adjust the first voltage level of the adjusting signal.

7. The display system as claimed in claim 6, wherein when the temperature falls, the thermal resistor changes the resistance value to decrease the first voltage level of the adjusting signal for increasing the first duty cycle of the pulse driving signal, and when the temperature rises, the thermal resistor changes the resistance value to increase the first voltage level of the adjusting signal for decreasing the first duty cycle of the pulse driving signal.

8. The display system as claimed in claim 1, wherein the pulse generating unit comprises:
a pulse width modulation controller, generating a pulse signal with a second duty cycle according to the first voltage level of the adjusting signal;
a driving circuit, generating a driving signal according to the pulse signal; and
a transformer, converting the pulse signal into the pulse driving signal;
wherein when the temperature falls, the first voltage level of the adjusting signal decreases to increase the second duty cycle of the pulse signal and the first duty cycle of the pulse driving signal, and when the temperature rises, the first voltage level of the adjusting signal increases to decrease the second duty cycle of the pulse signal and the first duty cycle of the pulse driving signal.

9. The display system as claimed in claim 8, wherein the pulse width modulation controller comprises:
a comparator, comparing the first voltage level of the adjusting signal to a reference voltage to generate a control signal with a second voltage level; and
a pulse generator, generating the pulse signal according to the control signal;
wherein when the temperature falls, the first voltage level of the adjusting signal decreases and the second voltage level of the control signal increases to increase the second duty cycle of the pulse signal, and when the temperature rises, the first voltage level of the adjusting signal increases and the second voltage level of the control signal decreases to decrease the second duty cycle of the pulse signal.

10. The display system as claimed in claim 8, wherein the thermal resistor is disposed near at least one of the pulse width modulation controller or the light tube to detect the temperature.

11. A display system, comprising
an adjusting unit, comprising a thermal resistor with a resistance value and generating an adjusting signal with a first voltage level according to a temperature;
a pulse width modulation controller, generating a first pulse signal with a first duty cycle and a second pulse signal with a second duty cycle according to the first voltage level of the adjusting signal;
a first driving circuit, generating a first driving signal according to the first pulse signal;
a second driving circuit, generating a second driving signal according to the second pulse signal;
a first transformer, receiving the first driving signal and the second driving signal to generate a pulse driving signal with a third duty cycle; and
a light tube, emitting light according to the third duty cycle of the pulse driving signal.

12. The display system as claimed in claim 11, wherein when the third duty cycle of the pulse driving signal increases, a emitting light time of the light tube increases and when the third duty cycle of the pulse driving signal decreases, the emitting light time of the light tube decreases.

13. The display system as claimed in claim 11, wherein the light tube is used in a liquid crystal display system.

14. The display system as claimed in claim 11, wherein the adjusting unit comprises:
a first resistor, coupled to the thermal resistor in parallel; and
a second resistor, coupled between ground and the thermal resistor.

15. The display system as claimed in claim 11, wherein the adjusting unit comprises:
a first resistor, coupled to the thermal resistor in series; and
a second resistor, coupled between ground and the thermal resistor.

16. The display system as claimed in claim 11, wherein the thermal resistor adjusts the resistance value according to the temperature to adjust the first voltage level of the adjusting signal.

17. The display system as claimed in claim 11, wherein when the temperature falls, the thermal resistor changes the resistance value to decrease the first voltage level of the adjusting signal for increasing the third duty cycle of the pulse driving signal, and when the temperature rises, the thermal resistor changes the resistance value to increase the first voltage level of the adjusting signal for decreasing the third duty cycle of the pulse driving signal.

18. The display system as claimed in claim 11, wherein the pulse width modulation controller comprises:
a comparator, comparing the first voltage level of the adjusting signal to a reference voltage to generate a control signal with a second voltage level; and
a pulse generator, generating the first pulse signal and the second pulse signal according to the control signal;
wherein when the temperature falls, the first voltage level of the adjusting signal decreases and the second voltage level of the control signal increases to increase the first duty cycle of the first pulse signal, the second duty cycle of the second pulse signal and the third duty cycle of the pulse driving signal, and when the temperature rises, the first voltage level of the adjusting signal increases and the second voltage level of the control signal decreases to decrease the first duty cycle of the first pulse signal, the second duty cycle of the second pulse signal and the third duty cycle of the pulse driving signal.

19. The display system as claimed in claim 11, wherein the thermal resistor is disposed near at least one of the pulse width modulation controller or the light tube to detect the temperature.

20. The display system as claimed in claim 11, wherein the thermal resistor is a negative temperature coefficient thermal resistor.
